(19) United States
(12) Patent Application Publication
(10) Pub. No.: US 2026/0088413 A1
(43) Pub. Date: Mar. 26, 2026

(54) ELECTRIC STORAGE APPARATUS AND VEHICLE MOUNTING STRUCTURE OF ELECTRIC STORAGE APPARATUS

(71) Applicant: TOYOTA JIDOSHA KABUSHIKI KAISHA, Aichi-ken (JP)

(72) Inventors: Naoya KAWAMOTO, Nisshin-shi (JP); Shigeyuki INOUE, Toyota-shi (JP); Nobuyoshi FUJIWARA, Nagoya-shi (JP); Kenta KIMURA, Toyota-shi (JP)

(73) Assignee: TOYOTA JIDOSHA KABUSHIKI KAISHA, Aichi-ken (JP)

(21) Appl. No.: 19/177,613

(22) Filed: Apr. 13, 2025

(30) Foreign Application Priority Data
Apr. 17, 2024 (JP) 2024-066912

(51) Int. Cl. H01M 50/24; B60K 1/04; H01M 50/204; H01M 50/242; H01M 50/249; H01M 50/271; H01M 50/291

(52) U.S. Cl. CPC H01M 50/24; B60K 1/04; H01M 50/242; H01M 50/249; H01M 50/271; H01M 50/291; B60K 2001/0438; H01M 50/204; H01M 2220/20

(57) ABSTRACT

An electric storage apparatus capable of reducing, even when a shared case is used, the number of occurrences of condensation inside the case is provided. An electric storage apparatus according to an aspect of the present disclosure includes: battery modules each of which includes a plurality of battery cells; and a case configured to house the battery modules, in which the electric storage apparatus includes: reinforcement members disposed between the battery modules; and filling members disposed between the case and each of the battery modules. Each of the reinforcement members includes a protrusion part configured to protrude toward an outside of the electric storage apparatus from an end part of each of the battery modules. The filling members overlap with the corresponding protrusion parts of the reinforcement members.

### CROSS REFERENCE TO RELATED APPLICATIONS

This application is based upon and claims the benefit of priority from Japanese patent application No. 2024-66912, filed on Apr. 17, 2024, the disclosure of which is incorporated herein in its entirety by reference.

### BACKGROUND

The present disclosure relates to an electric storage apparatus and a vehicle mounting structure of the electric storage apparatus.

As disclosed in Patent Literature 1, an ordinary electric storage apparatus has, for example, a configuration in which battery modules composed of stacked battery cells are arranged in a direction perpendicular to a stacking direction of the battery cells and housed in a case.

[Patent Literature 1] Japanese Unexamined Patent Application Publication No. 2022-128961

### SUMMARY

For example, when a shared case is used and an excess space is formed inside the case as a result of, for example, the number or the types of battery cells mounted in the case being changed, condensation may occur inside the case due to moisture contained in the air of the excess space.

The present disclosure has been made in view of the above-described problem and provides an electric storage apparatus and a vehicle mounting structure of the electric storage apparatus that are capable of reducing, even when a shared case is used, the number of occurrences of condensation inside the case.

An electric storage apparatus according to an aspect of the present disclosure includes:
battery modules each of which includes a plurality of battery cells stacked in a first direction; and
a case configured to house the battery modules, in which
the electric storage apparatus includes:
   reinforcement members disposed between the battery modules that are arranged in a second direction perpendicular to the first direction and an up-and-down direction, the reinforcement members extending in the first direction; and
   filling members disposed between the case and each of the battery modules in the first direction,
each of the reinforcement members includes a protrusion part configured to protrude toward an outside of the electric storage apparatus in the first direction from an end part of each of the battery modules as viewed from the second direction, and
the filling members overlap with the corresponding protrusion parts of the reinforcement members as viewed from the second direction.

In the above-described electric storage apparatus,
each of the filling members preferably includes a first member,
the first member preferably includes:
   a first part in contact with an upper case disposed above the battery modules in the case;
   a second part in contact with a lower case disposed below the battery modules in the case; and
   third parts configured to connect the first part to the second part, and
an area of the first part is preferably larger than areas of the third parts as viewed from the up-and-down direction.

In the above-described electric storage apparatus,
each of the filling members preferably includes a first member,
the first member preferably includes:
   a first part in contact with an upper case disposed above the battery modules in the case;
   a second part in contact with a lower case disposed below the battery modules in the case;
   third parts configured to connect the first part to the second part; and
   fourth parts configured to protrude in the second direction from the first part, and
each of the fourth parts is preferably supported by the respective protrusion part of each of the reinforcement members.

In the above-described electric storage apparatus, an area of the second part is preferably larger than the area of the third part as viewed from the up-and-down direction.

In the above-described electric storage apparatus,
each of the filling members preferably includes a second member, and
the second member is preferably disposed between a plurality of the third parts of the first member that are disposed so as to be spaced apart from each other in the second direction, and a density of the second member is smaller than a density of the first member.

A vehicle mounting structure of the electric storage apparatus according to an aspect of the present disclosure is a vehicle mounting structure of the above-described electric storage apparatus in which an upper case disposed above the battery modules in the case forms a floor surface of a vehicle interior part of a vehicle.

In the above-described vehicle mounting structure of the electric storage apparatus,
the vehicle preferably includes a pair of seat crosses extending in a width direction, and the filling members are preferably disposed between the pair of seat crosses as viewed from above.

In the above-described vehicle mounting structure of the electric storage apparatus, the filling members preferably overlap with at least a part of one of the pair of seat crosses as viewed from above.

According to the present disclosure, it is possible to provide an electric storage apparatus and a vehicle mounting structure of the electric storage apparatus that are capable of reducing, even when a shared case is used, the number of occurrences of condensation inside the case.

The above and other objects, features and advantages of the present disclosure will become more fully understood from the detailed description given hereinbelow and the accompanying drawings.

### BRIEF DESCRIPTION OF DRAWINGS

FIG. 1 is a diagram showing a state in which an electric storage apparatus according to an embodiment is mounted on a vehicle;

FIG. 2 is an exploded view showing the electric storage apparatus according to the embodiment in a simplified manner;

FIG. 3 is a diagram showing an arrangement of battery modules and filling members inside the electric storage apparatus according to the embodiment as viewed from a Z-axis positive side;

FIG. 4 is an X-Z cross-sectional view of the electric storage apparatus according to the embodiment;

FIG. 5 is a Y-Z cross-sectional view of the electric storage apparatus taken along a line V-V shown in FIG. 4;

FIG. 6 is a Y-Z cross-sectional view of the electric storage apparatus taken along a line VI-VI shown in FIG. 4;

FIG. 7 is a diagram showing a state in which the filling member is supported by a reinforcement member in the electric storage apparatus according to the embodiment; and

FIG. 8 is a perspective view showing the electric storage apparatus and a frame according to the embodiment.

### DESCRIPTION OF EMBODIMENTS

Specific embodiments to which the present disclosure is applied will be described hereinafter in detail with reference to the drawings. However, the present disclosure is not limited to the following embodiments. Further, for the clarification of the description, the following descriptions and drawings are simplified as appropriate. Note that the following description will be given using a three-dimensional (XYZ) coordinate system in order to clarify the description.

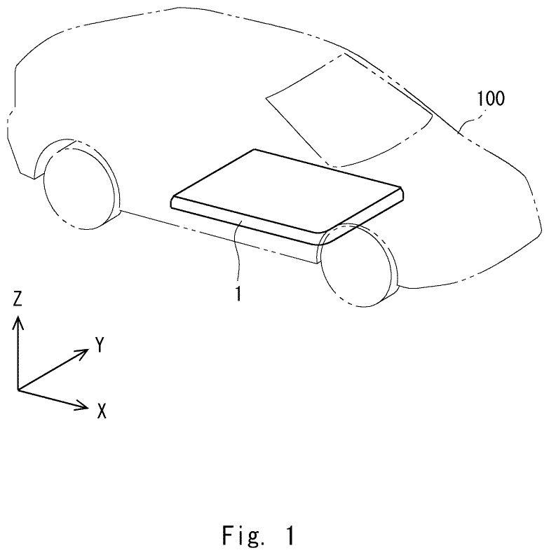

First, a configuration of an electric storage apparatus 1 according to this embodiment will be described. FIG. 1 is a diagram showing a state in which the electric storage apparatus according to this embodiment is mounted on a vehicle. As shown in FIG. 1, for example, the electric storage apparatus 1 is suitably used as an electric storage apparatus mounted on a vehicle 100.

In FIG. 1, the X-axis positive side is a front side of the vehicle 100, and the X-axis negative side is a rear side of the vehicle 100. The Y-axis positive side is a left side of the vehicle 100, and the Y-axis negative side is a right side of the vehicle 100. The Z-axis positive side is an upper side of the vehicle 100, and the Z-axis negative side is a lower side of the vehicle 100. That is, it is assumed that the vehicle 100 is disposed in a horizontal plane.

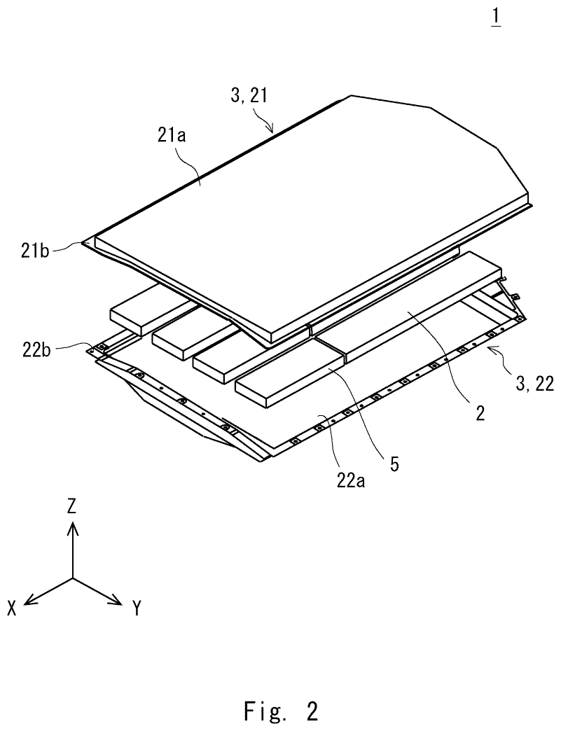

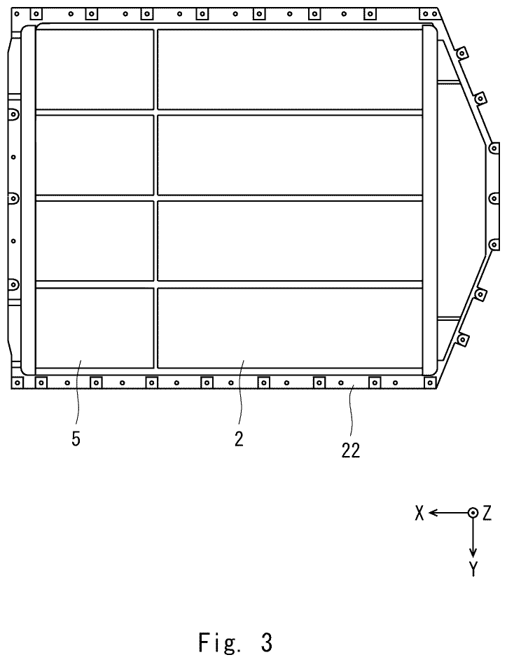

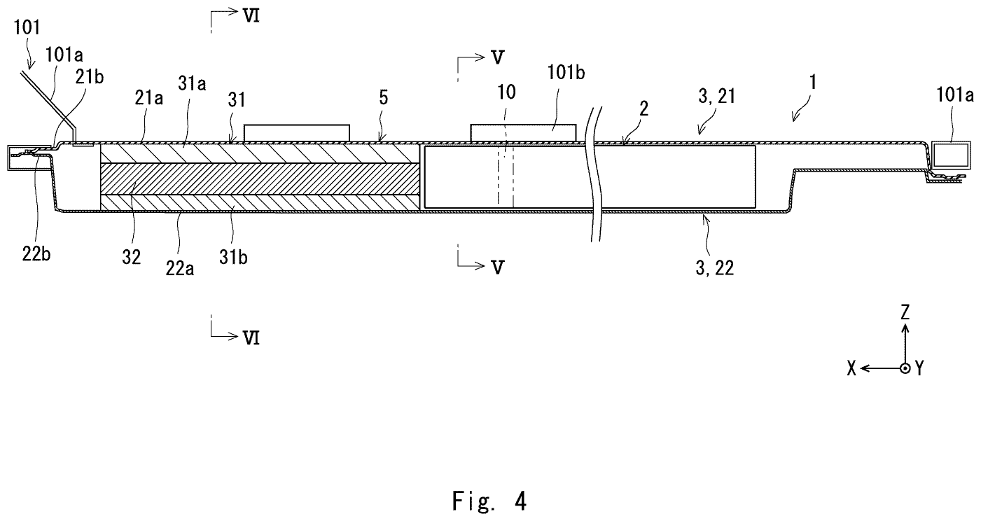

FIG. 2 is an exploded view showing the electric storage apparatus according to this embodiment in a simplified manner. FIG. 3 is a diagram showing an arrangement of battery modules and filling members inside the electric storage apparatus according to the embodiment as viewed from a Z-axis positive side. FIG. 4 is an X-Z cross-sectional view of the electric storage apparatus according to this embodiment.

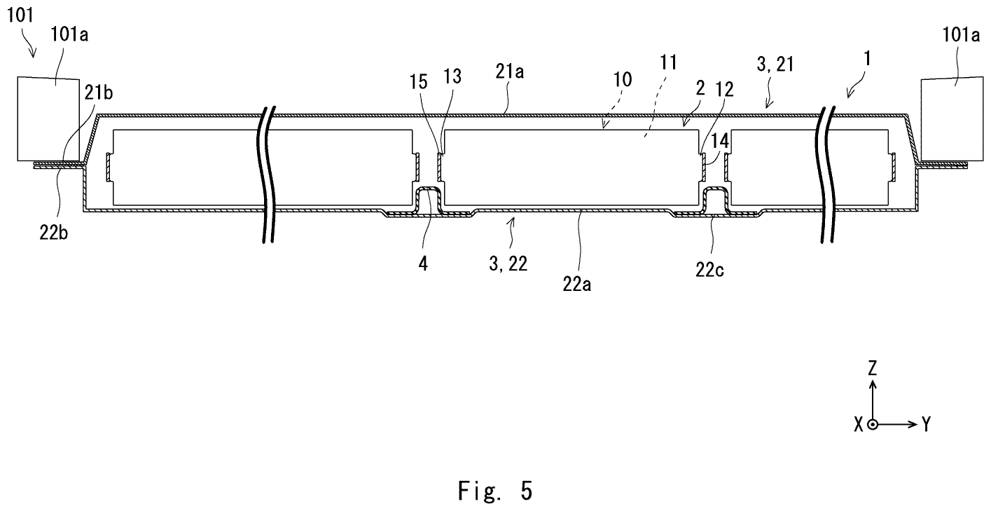

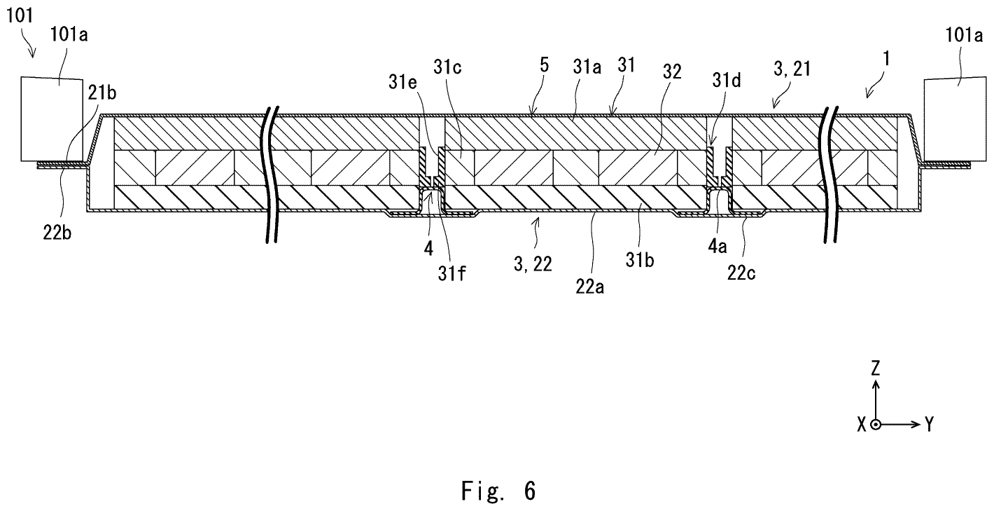

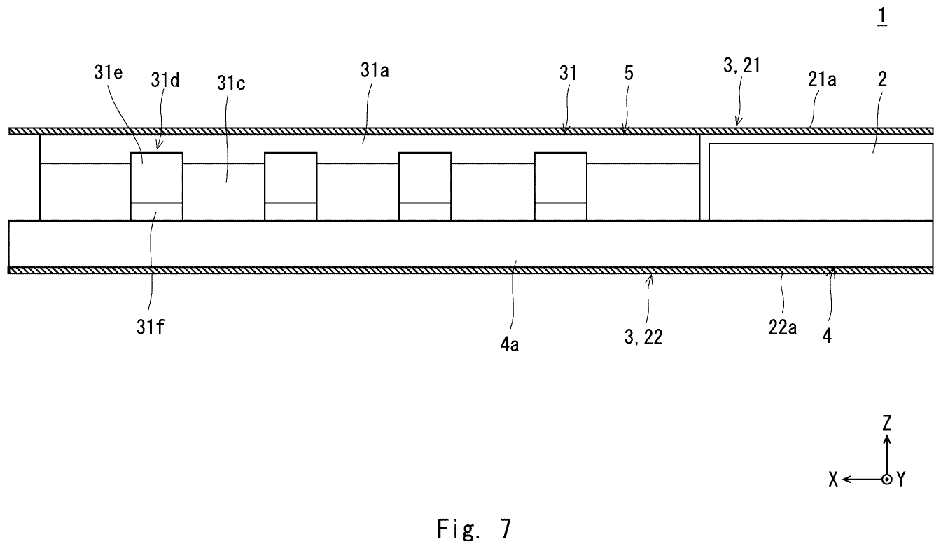

FIG. 5 is a Y-Z cross-sectional view of the electric storage apparatus taken along a line V-V shown in FIG. 4. FIG. 6 is a Y-Z cross-sectional view of the electric storage apparatus taken along a line VI-VI shown in FIG. 4. FIG. 7 is a diagram showing a state in which the filling member is supported by a reinforcement member in the electric storage apparatus according to this embodiment.

As shown in FIGS. 2 to 7, the electric storage apparatus 1 includes battery modules 2, a pack case 3, reinforcement members 4, and filling members 5. Each of the battery modules 2 includes a plurality of battery cells 10. Each of the battery cells 10 comprises, for example, an electrode body housed inside a battery case 11 as shown in FIG. 5.

For example, as shown in FIG. 5, a first electrode terminal 12, which is one of a positive electrode terminal and a negative electrode terminal, is provided in an end part of the battery case 11 on the Y-axis positive side thereof, and a second electrode terminal 13, which is the other of the positive electrode terminal and the negative electrode terminal, is provided in an end part of the battery case 11 on the Y-axis negative side thereof.

The battery cells 10 described above are stacked in the X-axis direction so that the positive electrode terminal and the negative electrode terminal are disposed alternately in the X-axis direction (a first direction) on each of the Y-axis positive side and the Y-axis negative side of the battery module 2.

Further, as shown in FIG. 5, the first electrode terminals 12 adjacent to each other in the X-axis direction are electrically connected through a first bus bar 14 on the Y-axis positive side of the battery module 2, and the second electrode terminals 13 adjacent to each other in the X-axis direction are electrically connected through a second bus bar 15 on the Y-axis negative side of the battery module 2. Thus, the battery cells 10 constituting the battery module 2 are electrically connected to each other in series.

As shown in FIGS. 2 to 7, the pack case 3 houses the battery modules 2. The pack case 3 includes an upper case 21 and a lower case 22. The upper case 21 includes, for example, a housing part 21a which is configured so as to rise up toward the Z-axis positive side and includes an internal space in which the battery modules 2 can be housed, and a flange part 21b which protrudes outward from the periphery of the housing part 21a.

As shown in FIGS. 2 to 7, the lower case 22 includes, for example, a housing part 22a which is recessed toward the Z-axis negative side and includes an internal space in which the battery module 2 can be housed, and a flange part 22b which protrudes outward from the periphery of the housing part 22a.

The flange part 21b of the upper case 21 and the flange part 22b of the lower case 22 are joined to each other by an adhesive member while the battery modules 2 disposed at predetermined intervals in the Y-axis direction (a second direction) are housed inside the housing part 21a of the upper case 21 and the housing part 22a of the lower case 22 described above.

Note that, as shown in FIGS. 2 and 3, an excess space is formed inside the pack case 3 between each of the battery modules 2 and the pack case 3 on the X-axis positive side or the X-axis negative side of the battery modules 2. That is, the battery modules 2 are not disposed inside the pack case 3 so that almost the entire area of the pack case 3 in the X-axis direction is filled with the battery modules 2.

Note that, for example, the battery modules 2 are preferably disposed inside the pack case 3 on the side where a device such as a junction box is disposed. For example, when a device such as a junction box is disposed on the X-axis negative side of the electric storage apparatus 1, the battery modules 2 are preferably disposed inside the pack case 3 on the X-axis negative side thereof as shown in FIGS. 2 and 3.

Therefore, in this embodiment, as shown in FIGS. 2 and 3, the battery modules 2 are disposed in the electric storage apparatus 1 on the X-axis negative side thereof. Thus, the wiring extending from a device such as a junction box to the respective battery cells 10 can be shortened, and thus the arrangement of the wiring can be simplified.

The reinforcement member 4 is, for example, a rigid member which, when a load in the X-axis direction is input to the electric storage apparatus 1, receives the load. As shown in FIGS. 5 to 7, the reinforcement member 4 is disposed between each adjacent pair of the battery modules 2 adjacent in the Y-axis direction in a space on the Z-axis negative side of the first bus bar 14 and the second bus bar 15 that are positioned opposite to each other along the Y-axis direction, and extends in the X-axis direction.

As shown in FIGS. 5 and 6, for example, the reinforcement member 4 has a substantially hat shape as viewed from the X-axis direction, and an end part of the reinforcement member 4 on the Z-axis negative side thereof is fixed to a surface of the housing part 22a of the lower case 22 on the Z-axis positive side thereof.

Note that, for example, a part of the reinforcement member 4 on the Z-axis negative side thereof may be housed in a recessed part 22c formed in the housing part 22a of the lower case 22 as shown in FIGS. 5 and 6. However, the shape of the reinforcement member 4 is not limited, and may be any shape that is long in the X-axis direction.

For example, an end part of the reinforcement member 4 on the X-axis positive side thereof may reach the vicinity of an end part of the housing part 22a of the lower case 22 on the X-axis positive side thereof, and an end part of the reinforcement member 4 on the X-axis negative side thereof may reach the vicinity of an end part of the housing part 22a of the lower case 22 on the X-axis negative side thereof.

Therefore, as viewed from the Y-axis direction, the end part of the reinforcement member 4 on the X-axis negative side thereof is disposed near an end part of the battery module 2 on the X-axis negative side thereof, and a part of the reinforcement member 4 on the X-axis positive side thereof protrudes from an end part of the battery module 2 on the X-axis positive side thereof toward the X-axis positive side. That is, as shown in FIG. 7, the reinforcement member 4 includes a protrusion part 4a which protrudes closer to the X-axis positive side than the battery module 2 does.

Note that, as viewed from the Z-axis direction, the reinforcement member 4 may overlap with at least a part of the first bus bar 14 and the second bus bar 15 that are positioned opposite to each other along the Y-axis direction. Thus, a space on the Z-axis negative side of the first bus bar 14 and the second bus bar 15 that are positioned opposite to each other along the Y-axis direction can be effectively used, and hence it is possible to contribute to the reduction of the size of the electric storage apparatus 1.

The filling members 5 fill an excess space inside the pack case 3 between each of the battery modules 2 and the pack case 3. As shown in FIGS. 6 and 7, for example, each of the filling members 5 is a block member extending in the X-axis direction and includes a first member 31 and a second member 32.

The first member 31 is, for example, an aggregate of the filling member 5 as shown in FIGS. 4 and 6. The first member 31 includes a first part 31a, a second part 31b, third parts 31c, and fourth parts 31d.

As shown in FIGS. 4 and 6, the first part 31a is disposed in an end part of the first member 31 on the Z-axis positive side thereof, and forms a beam member of the first member 31 on the Z-axis positive side thereof. The first part 31a is, for example, a rectangular flat plate substantially parallel to the XY plane, and may be composed of a metal plate, an aluminum plate, or a resin plate having rigidity.

As shown in FIG. 4, a length of the first part 31a in the X-axis direction is, for example, a desired length such that an excess space inside the pack case 3 between each of the battery modules 2 and the pack case 3 can be filled with the filling members 5. As shown in FIG. 6, the length of the first part 31a in the Y-axis direction, for example, is substantially the same as the length of the battery cell 10 in the Y-axis direction.

As shown in FIGS. 4 and 6, the second part 31b is disposed in an end part of the first member 31 on the Z-axis negative side thereof, and forms a beam member of the first member 31 on the Z-axis negative side thereof. The second part 31b has a configuration substantially the same as that of the first part 31a, and overlaps with the first part 31a as viewed from the Z-axis direction in a state in which it is disposed on the Z-axis negative side of the first part 31a.

As shown in FIG. 6, the third parts 31c are disposed in the first member 31 at intervals in the Y-axis direction, and forms a column member of the first member 31. Each of the third parts 31c has, for example, a plate body substantially parallel to the XZ plane, and may be composed of, for example, a corrugated metal plate or a corrugated aluminum plate, an aluminum cast plate, an aluminum extrusion plate, or a resin plate having rigidity.

The length of the third part 31c in the X-axis direction, for example, is substantially the same as the length of the first part 31a in the X-axis direction as shown in FIG. 7. Further, the length of the third part 31c in the Y-axis direction, for example, is shorter than the length of the first part 31a in the Y-axis direction as shown in FIG. 6.

As shown in FIG. 6, the third parts 31c connect the first part 31a to the second part 31b. For example, the third parts 31c connect an end part of the first part 31a on the Y-axis positive side thereof to an end part of the second part 31b on the Y-axis positive side thereof, and an end part of the first part 31a on the Y-axis negative side thereof to an end part of the second part 31b on the Y-axis negative side thereof.

Thus, a space surrounded by the first part 31a, the second part 31b, and the third part 31c is formed. Note that, as viewed from the Z-axis direction, the area of the first part 31a and the area the second part 31b are larger than the total area of all the third parts 31c.

Note that, as shown in FIG. 6, the third part 31c may further connect the first part 31a to the second part 31b between the third part 31c on the Y-axis positive side and the third part 31c on the Y-axis negative side.

As shown in FIGS. 6 and 7, each of the fourth parts 31d protrudes from the first part 31a in the Y-axis direction, and is a shoulder member for making the reinforcement member 4 support the first member 31. Each of the fourth parts 31d has, for example, a substantially L-shape as viewed from the X-axis direction, and includes a vertical part 31e and a horizontal part 31f protruding in the Y-axis direction from an end part of the vertical part 31e on the Z-axis negative side thereof.

The length of the fourth part 31d in the X-axis direction, for example, is shorter than the length of the first member 31 in the X-axis direction. Further, the length of the fourth part 31d in the Y-axis direction is, for example, less than half of the distance between the battery cases 11 of the battery modules 2 that are positioned opposite to each other along the Y-axis direction.

As shown in FIG. 6, the vertical part 31e of the fourth part 31d is, for example, connected to at least one of the end part of the first part 31a on the Y-axis positive side thereof and an end part of the third part 31c on the Y-axis positive side thereof located on the Y-axis positive side, and the end part of the first part 31a on the Y-axis negative side thereof and an end part of the third part 31c on the Y-axis negative side thereof located on the Y-axis negative side. Note that, as shown in FIG. 7, the fourth parts 31d are disposed at intervals in the X-axis direction.

Thus, as shown in FIG. 6, the fourth part 31d protrudes either toward the Y-axis positive side from the first part 31a and the third part 31c on the Y-axis positive side or toward the Y-axis negative side from the first part 31a and the third part 31c on the Y-axis negative side.

Specifically, the filling member 5 disposed in the excess space on the X-axis positive side of the battery module 2 disposed on the Y-axis positive side among the battery modules 2 arranged in the Y-axis direction may have a configuration in which the fourth part 31d protrudes toward the Y-axis negative side from the first member 31 and the third part 31c on the Y-axis negative side.

Further, the filling member 5 disposed in the excess space on the X-axis positive side of the battery module 2 disposed on the Y-axis negative side among the battery modules 2 arranged in the Y-axis direction may have a configuration in which the fourth part 31d protrudes toward the Y-axis positive side from the first member 31 and the third part 31c on the Y-axis positive side.

Further, the filling member 5 disposed in the excess space on the X-axis positive side of the battery module 2 disposed between the battery module 2 disposed on the Y-axis positive side and the battery module 2 disposed on the Y-axis negative side among the battery modules 2 arranged in the Y-axis direction may have a configuration in which the fourth part 31d protrudes toward the Y-axis positive side from the first member 31 and the third part 31c on the Y-axis positive side and protrudes toward the Y-axis negative side from the first member 31 and the third part 31c on the Y-axis negative side.

In the above first members 31, as shown in FIG. 6, the height from an end part of the second part 31b on the Z-axis negative side thereof to an end part of the horizontal part 31f of the fourth part 31d on the Z-axis negative side thereof may be substantially the same as the height of the reinforcement member 4 in the Z-axis direction.

The second member 32 may be any member having a density smaller than that of the first member 31, such as foamed urethane. As shown in FIGS. 4 and 6, the second member 32 is disposed in the space surrounded by the first part 31a, the second part 31b, and the third part 31c.

Note that, in order to reduce an excess space inside the pack case 3, the second member 32 may be disposed so as to fill the entire space surrounded by the first part 31a, the second part 31b, and the third part 31c.

As shown in FIG. 7, the above-described filling member 5 is disposed on the X-axis positive side of the battery module 2 so as to fill an excess space inside the pack case 3 between the battery module 2 and the pack case 3, and overlaps with the protrusion part 4a of the reinforcement member 4 as viewed from the Y-axis direction. Further, the filling member 5 is disposed so as to substantially overlap with the battery module 2 as viewed from the X-axis direction.

Note that, as shown in FIGS. 4 and 6, an end part of the first part 31a of the first member 31 of the filling member 5 on the Z-axis positive side thereof may be in contact with a surface of the housing part 21a of the upper case 21 on the Z-axis negative side thereof, and an end part of the second part 31b of the first member 31 on the Z-axis negative side thereof may be in contact with a surface of the housing part 22a of the lower case 22 on the Z-axis positive side thereof.

Thus, a path through which a load input to the upper case 21 is released to the lower case 22 via the first part 31a, the third parts 31c, and the second part 31b of the first member 31 can be formed.

Further, a path through which a load input to the lower case 22 is released to the upper case 21 via the second part 31b, the third parts 31c, and the first part 31a of the first member 31 can be formed.

Further, as shown in FIGS. 6 and 7, an end part of the horizontal part 31f of the fourth part 31d of the first member 31 of the filling member 5 on the Z-axis negative side thereof is in contact with an end part of the protrusion part 4a of the reinforcement member 4 on the Z-axis positive side thereof in a state in which the filling member 5 is supported by the housing part 22a of the lower case 22.

Thus, not only a path through which a load input to the electric storage apparatus 1 from the Z-axis positive side of the filling member 5 is released to the lower case 22 via the first part 31a, the third parts 31c, and the second part 31b of the first member 31, but also a path through which a load input to the electric storage apparatus 1 from the Z-axis positive side of the filling member 5 is released to the reinforcement member 4 via the fourth parts 31d of the first member 31 can be formed.

As described above, in the electric storage apparatus 1 according to this embodiment, an excess space inside the pack case 3 between the battery modules 2 and the pack case 3 is filled with the filling members 5. Therefore, an excess space inside the electric storage apparatus 1 can be reduced, and the number of occurrences of condensation inside the electric storage apparatus 1 can be reduced.

Moreover, in the electric storage apparatus 1 according to this embodiment, as viewed from the Y-axis direction, since the filling member 5 is disposed so as to overlap with the protrusion part 4a of the reinforcement member 4, the number of occurrences of condensation inside the electric storage apparatus 1 can be reduced and the rigidity of the electric storage apparatus 1 in the X-axis direction can be improved.

Further, in the electric storage apparatus 1 according to this embodiment, when the end part of the first part 31a of the first member 31 of the filling member 5 on the Z-axis positive side thereof comes into contact with the surface of the housing part 21a of the upper case 21 on the Z-axis negative side thereof, and the end part of the second part 31b of the first member 31 on the Z-axis negative side thereof comes into contact with the surface of the housing part 22a of the lower case 22 on the Z-axis positive side thereof, a load input to the electric storage apparatus 1 from the Z-axis positive side can be satisfactorily released from the upper case 21 to the lower case 22, and a load input to the electric storage apparatus 1 from the Z-axis negative side can be satisfactorily released from the lower case 22 to the upper case 21.

Further, in the electric storage apparatus 1 according to this embodiment, when the area of the first part 31a of the first member 31 of the filling member 5 is larger than the total area of all the third parts 31c, a contact area where the first part 31a of the first member 31 is in contact with the upper case 21 can be increased, and a load input to the electric storage apparatus 1 from the Z-axis positive side can be satisfactorily released from the upper case 21 to the filling member 5.

Similarly, in the electric storage apparatus 1 according to this embodiment, when the area of the second part 31b of the first member 31 of the filling member 5 is larger than the total area of all the third parts 31c, a contact area where the second part 31b of the first member 31 is in contact with the lower case 22 can be increased, and a load input to the electric storage apparatus 1 from the Z-axis negative side can be satisfactorily released from the lower case 22 to the filling member 5.

Further, in the electric storage apparatus 1 according to this embodiment, when the filling member 5 is supported by the reinforcement member 4 through the fourth part 31d of the first member 31, a load input to the electric storage apparatus 1 from the Z-axis positive side can also be satisfactorily released to the reinforcement member 4.

Further, in the electric storage apparatus 1 according to this embodiment, when the first member 31 of the filling member 5 forms the aggregate of the filling member 5 and a space formed by the first member 31 is filled with the second member 32 having a density smaller than that of the first member 31, an excess space of the electric storage apparatus 1 can be reduced.

Moreover, the weight of the filling member 5 can be reduced, and as a result, the weight of the electric storage apparatus 1 can be reduced.

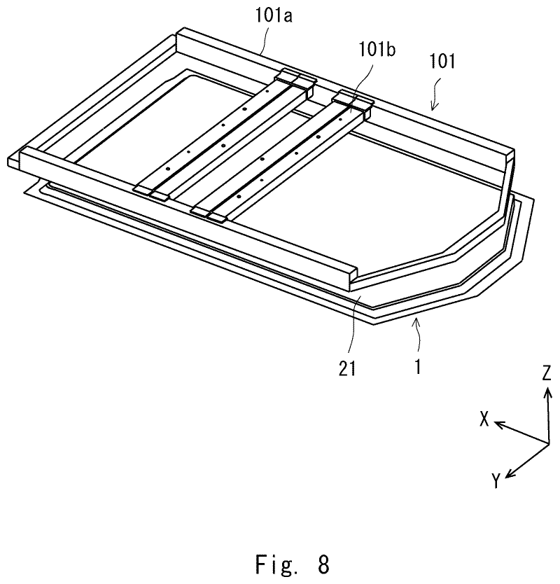

Next, a preferred structure in which the electric storage apparatus 1 according to this embodiment is mounted on the vehicle 100 will be described. FIG. 8 is a perspective view showing the electric storage apparatus and a frame according to this embodiment. As shown in FIG. 8, a frame 101 forms a vehicle frame member of the vehicle 100.

As shown in FIG. 8, the frame 101 includes, for example, a main body part 101a formed in a frame shape as viewed from the Z-axis direction, and beam parts 101b each of which is fixed to the main body part 101a so as to extend from a part of the main body part 101a extending in the X-axis direction on the Y-axis positive side thereof to a part of the main body part 101a extending in the X-axis direction on the Y-axis negative side thereof.

As shown in FIG. 8, each of the beam parts 101b, for example, extends in the Y-axis direction, and is a seat cross to which the seat of the vehicle 100 is fixed. The beam parts 101b, for example, are disposed at intervals in the X-axis direction.

In the above-described frame 101, as shown in FIGS. 4 to 6, the flange part 21b of the upper case 21 of the pack case 3 of the electric storage apparatus 1 and the flange part 22b of the lower case 22 of the electric storage apparatus 1, for example, may be fixed to the main body part 101a of the frame 101 from below.

Note that, as shown in FIG. 4, as viewed from the Z-axis direction, the electric storage apparatus 1 may be fixed to the frame 101 of the vehicle 100 so that at least a part of the filling member 5 is disposed between beam parts 101b of the frame 101.

Further, the upper case 21 of the electric storage apparatus 1 may form a floor surface (a floor panel) of a vehicle interior part of the vehicle 100. When a vehicle interior part of the vehicle 100 is formed in this way, a floor mat, a floor silencer, or the like may be disposed on the surface of the upper case 21 of the electric storage apparatus 1 on the Z-axis positive side thereof.

That is, the filling member 5 may be disposed at a position where it is likely to receive a load from the Z-axis direction since the filling member 5 is less adversely affected by the load than the battery cell 10 is. By so disposing the filling member 5, the structure in which the electric storage apparatus 1 is mounted on the vehicle 100 according to this embodiment can reduce an adverse effect caused by a load input to the battery cell 10.

Moreover, when a floor surface of a vehicle interior part of the vehicle 100 is formed by the upper case 21 of the electric storage apparatus 1, it is not required to provide another floor surface in the frame 101 like that provided in an ordinary vehicle. Therefore, the weight of the vehicle 100 can be reduced.

Further, when the electric storage apparatus 1 is mounted on the vehicle 100, the electric storage apparatus 1 can be disposed at a position high above the ground, and thus the minimum height of the electric storage apparatus 1 above the ground can be secured. However, a part of the filling member 5 may be disposed so as to overlap with the beam part 101b of the frame 101 as viewed from the Z-axis direction. Further, the upper case 21 of the electric storage apparatus 1 may be fixed to the beam parts 101b of the frame 101.

The present disclosure is not limited to the above-described embodiments and can be changed as appropriate without departing from the scope and spirit of the present disclosure.

For example, in the above-described embodiments, although the battery cell 10 is stacked in the X-axis direction, it may be stacked in the Y-axis direction, and an arrangement of the reinforcement members 4 and the filling members 5 may be changed as appropriate in accordance with the stacking direction of the battery cell 10.

For example, in the battery cell 10 according to the above-described embodiments, the first electrode terminal 12 is provided in an end part of the battery case 11 on the Y-axis positive side thereof, and the second electrode terminal 13 is provided in an end part of the battery case 11 on the Y-axis negative side thereof. However, an arrangement of the first electrode terminal 12 and the second electrode terminal 13 is not limited, and the first electrode terminal 12 and the second electrode terminal 13, for example, may be provided in an end part of the battery case 11 on the Z-axis positive side thereof.

For example, the structure of each of the filling members 5 according to the above-described embodiments is merely an example, and the filling members 5 may have any shape which enables an excess space inside the electric storage apparatus 1 to be filled with the filling members 5, and the length of each of the filling members 5 in the X-axis direction may be substantially the same as that of the battery cell 10. Further, the fourth parts 31d of the first member 31 of the filling member 5 may be omitted.

For example, the filling member 5 may protrude closer to the Y-axis positive side and the Y-axis negative side than the battery cell 10 does as viewed from the X-axis direction. Thus, when an impact is applied to the electric storage apparatus 1 from the Y-axis direction, the filling member 5 comes into contact with the reinforcement member 4 before the battery cell 10 comes into contact with the reinforcement member 4, and the battery cell 10 can be prevented from being damaged.

For example, the first part 31a of the first member 31 of the filling member 5 according to the above-described embodiments may come into contact directly with the surface of the housing part 21a of the upper case 21 on the Z-axis negative side thereof, or may come into contact with the surface of the housing part 21a of the upper case 21 on the Z-axis negative side thereof through a plate member having rigidity such as a surface pressure dispersion member for dispersing a load input to the electric storage apparatus 1 from the Z-axis positive side.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An electric storage apparatus comprising:
battery modules each of which comprises a plurality of battery cells stacked in a first direction; and
a case configured to house the battery modules, wherein the electric storage apparatus comprises:
reinforcement members disposed between the battery modules that are arranged in a second direction perpendicular to the first direction and an up-and-down direction, the reinforcement members extending in the first direction; and
filling members disposed between the case and each of the battery modules in the first direction,
each of the reinforcement members comprises a protrusion part configured to protrude toward an outside of the electric storage apparatus in the first direction from an end part of each of the battery modules as viewed from the second direction, and
the filling members overlap with the corresponding protrusion parts of the reinforcement members as viewed from the second direction.

2. The electric storage apparatus according to claim 1, wherein
each of the filling members comprises a first member,
the first member comprises:
a first part in contact with an upper case disposed above the battery modules in the case;
a second part in contact with a lower case disposed below the battery modules in the case; and
third parts configured to connect the first part to the second part, and
an area of the first part is larger than areas of the third parts as viewed from the up-and-down direction.

3. The electric storage apparatus according to claim 1, wherein
each of the filling members comprises a first member,
the first member comprises:
a first part in contact with an upper case disposed above the battery modules in the case;
a second part in contact with a lower case disposed below the battery modules in the case; and
third parts configured to connect the first part to the second part; and
fourth parts configured to protrude in the second direction from the first part, and
each of the fourth parts is supported by the respective protrusion part of each of the reinforcement members.

4. The electric storage apparatus according to claim 2, wherein an area of the second part is larger than the areas of the third parts as viewed from the up-and-down direction.

5. The electric storage apparatus according to claim 4, wherein
each of the filling members comprises a second member, and
the second member is disposed between a plurality of the third parts of the first member that are disposed so as to be spaced apart from each other in the second direction, and a density of the second member is smaller than a density of the first member.

6. A vehicle mounting structure of the electric storage apparatus according to claim 1, wherein an upper case disposed above the battery modules in the case forms a floor surface of a vehicle interior part of a vehicle.

7. The vehicle mounting structure of the electric storage apparatus according to claim 6, wherein
the vehicle comprises a pair of seat crosses extending in a width direction, and
the filling members are disposed between the pair of seat crosses as viewed from above.

8. The vehicle mounting structure of the electric storage apparatus according to claim 7, wherein the filling members overlap with at least a part of one of the pair of seat crosses as viewed from above.
